(19) United States
(12) Patent Application Publication
(10) Pub. No.: US 2003/0063475 A1
(43) Pub. Date: Apr. 3, 2003

(54) Retractable and concealable rearward light system for a vehicle

(76) Inventor: Michael Simmons, Thomasville, GA (US)

Correspondence Address: Brian D. Bellamy, P.O. Box 1997, Thomasville, GA, 31799-1997, US

(21) Appl. No.: 10/037,730

(22) Filed: Nov. 9, 2001

Related U.S. Application Data
(60) Provisional application No. 60/326,551, filed on Oct. 2, 2001.

(51) Int. Cl. F21V 21/26

(52) U.S. Cl. 362/526; 362/485; 362/428

(57) ABSTRACT

A retractable light system is concealed beneath a vehicle and is exposed when desired to provide rearward lighting from the vehicle. A holding frame having a rotating shaft is attached to the undersurface of the vehicle by a bearing or bracket and supports lights that rotate between a first position where the lights are retracted beneath the undersurface of the vehicle and a second position where the lights are extended below the vehicle and provide rearward lighting. The rotational mechanism for moving the lights to the deactivated and activated positions may include a motor coupled to the holding frame by a cable. Guards may be provided on the light system to protect the lights from damage. The holding frame may be attached to an accessory trailer hitch beneath the vehicle rather than directly to the vehicle. And, the retractable light system may be activated or deactivated by a remote control device such as a key chain remote.

### PRIORITY CLAIM

The priority of U.S. Provisional Application No. 60/326551 filed Oct. 2, 2001 is claimed.

### BACKGROUND OF THE INVENTION

1. Field of the Invention

The present invention relates generally to an exterior lighting system for use on a motor vehicle especially those equipped with towing capabilities. More particularly, the present invention relates to a retractable lighting system designed and configured to successfully provide additional rearward illumination for the motor vehicle for inherently increasing visibility and adding to motor safety, especially when towing trailers or the like, while providing retractable capabilities so as to innately render a system that, when not in use, is retracted and hidden from view so as to not adversely affect the aerodynamic or aesthetic properties of the particular vehicle.

2. Description of the Prior Art

When a vehicle, generally a truck, is towing a trailer additional rearward lighting is usually desired. The use of additional rearward lighting increases visibility for consequently adding to motor vehicle safety. Conventionally, rearward lighting is provided on trailers by providing the lighting system of the trailer to be coupled to the existing lighting system of the motor vehicle. Though somewhat successful, this system of coupling can be time consuming and in addition is not trouble free in operation. The light system of the trailer can disconnect or even malfunction, causing the trailer lighting system to fail causing decreased visibility and defeating its intended purpose. The driver may not readily realize this lighting failure.

Devices have been developed for increasing rearward lighting when towing a vehicle. These devices typically comprise an elongated shaft or the like that is permanently affixed to the top or rear of the particular vehicle. Though successful, this type of device provides for a vehicle, which is not aerodynamic, consequently providing an automobile that requires an increase in fuel consumption for use.

Accordingly, it is seen that what is needed is a retractable lighting system secured to a motor vehicle that can efficiently be extended and positioned for visibility when in use and retracted and non-obtrusive for storing when not in use. The lighting system should be successful in use and optionally can be controlled via a remote apparatus to provide for an exterior illumination system that is not only efficient, but one that is adequate in providing additional rearward illumination capability.

As will be seen, the present invention achieves its intended purposes, objectives and advantages by accomplishing the needs as identified above, through a new, useful and unobvious combination of component elements, which is simple to use, with the utilization of a minimum number of functioning parts, at a reasonable cost to manufacture, assemble, test and by employing only readily available material.

### SUMMARY OF THE INVENTION

The present invention is a retractable and concealable rearward light system that is designed and configured to provide additional rearward lighting or optionally, to provide for additional exterior lighting when desired. The system is designed to operate automatically when the automobile is placed into the reverse gear, or optionally, manually, when commanded via a remote control device, such as a programmable key chain remote. The system may be programmed prior to installation or after installation by a remote control to activate according to the desired characteristics of the system. For instance, the system may be programmed only to operate manually and to remain concealed while a vehicle is in reverse gear unless manually actuated. In either instance, the present invention will successfully provide additional illumination capabilities for innately optimizing viewing capabilities for the user. The present invention is also designed to be stored under the vehicle and hidden in a non-obtrusive position, so as to not adversely affect the aerodynamics of the vehicle when the lights are not in use. Thus, the invention innately provides a system that will automatically lower lights when desired and retract the lights to a hide-away position when rearward or exterior lighting is not necessary.

To provide for such a configuration, the present invention includes an axle or shaft that is rotatably mounted to the undersurface of a vehicle. This shaft maintains the lights used for illumination. A control box, preferably located in proximity to the motor of the vehicle, is used for actuating the appropriate rotational mechanism for upward and downward movement of the lights, and thus is coupled, via a wiring harness to the rotational mechanism apparatus. This rotational mechanism will provide a means of rotating the shaft in a particular direction, consequently causing the downward positioning of lights (actuation of illumination system) or upward positioning of lights (storage position).

In essence, when the control box receives a signal, such as when the motor vehicle is placed in reverse or the remote device is activated, the control station will transmit the signal to the rotational mechanism apparatus. The rotational mechanism will activate and thus cause the rotation, in the desired direction, of the axle used in the light assembly. If rotated downward, the lights are illuminated. If rotated upward, the lights are deactivated and stored in a non-obtrusive position.

Accordingly, it is an object of the present invention to provide a retractable light system that will overcome the deficiencies, shortcomings, and drawbacks of prior reverse lighting systems and methods thereof.

Another object of the present invention is to provide a reverse light system that will adequately and efficiently provide additional illumination capabilities when in a usable position providing a non-obtrusive position when stored. Intrinsically adding to visibility when in use and eliminating any aerodynamic problems generally associated with the added conventional lighting systems.

Yet a further object of the present invention, to be specifically enumerated herein, is to provide a reverse light system in accordance with proceeding objects and which will conform to conventional forms of manufacture, be of simple construction and easy to use and install onto conventional motor vehicles so as to provide for a reverse light system that includes retractable characteristics so as to provide for a system that is economical during vehicle use when system is not activated, long lasting and relatively trouble free during utilization.

Although there have been inventions related to reverse lighting systems, none of the inventions have successfully provide a means of storing the lights in a non-obstructive position when the system is not in use. In addition prior light systems are silent to a means of light activation via the use of a remote control device so as to provide for a system that enables exterior illumination even when the motor vehicle is not in a reverse placement. The present invention meets the requirements of the simplified design, compact size, low initial cost, low operating cost, ease of installation and maintainability, and minimal amount of training to successfully employ the invention.

The foregoing has outlined some of the more pertinent objects of the invention. These objects should be construed to be merely illustrative of some of the more prominent features and application of the intended invention. Many other beneficial results can be obtained by applying the disclosed invention in a different manner or modifying the invention within the scope of the disclosure. Accordingly, a fuller understanding of the invention may be had by referring to the detailed description of the preferred embodiments in addition to the scope of the invention defined by the claims taken in conjunction with the accompanying drawings.

### BRIEF DESCRIPTION OF THE DRAWINGS

FIG. 1 is a rear view of a conventional motor vehicle having the present invention installed thereto and illustrating the retractable light system of the present invention in a downward and useable position.

FIG. 2 is a perspective exploded view of the shaft and illumination apparatus used in the retractable light system of the present invention.

FIG. 3 is a side perspective view of the shaft and illumination apparatus and its attaching element used to maintain the retractable light system of the present invention to a motor vehicle.

FIG. 4 is a schematic and bottom plan view of the shaft and illumination apparatus illustrating an alternative means of attachment to the frame member of a trailer hitch on the motor vehicle.

FIG. 5a is a side view of the rotational shaft of the illumination apparatus of the retractable light system of the present invention, in an upward and storable position.

FIG. 5b is a side view of the rotational shaft of the illumination apparatus of the retractable light system of the present invention, extending in the downward position.

FIG. 5c is a side view of the rotational shaft of the illumination apparatus of the retractable light system of the present invention, in a downward and useable position.

FIG. 6 is a schematic and bottom plan view of the present invention attached to the undersurface of a conventional motor vehicle.

FIG. 7 is a bottom plan view of the present invention attached to the undersurface of a conventional motor vehicle having protective covering surrounding wiring used with the present invention.

Similar reference numerals refer to similar parts throughout the several views of the drawings.

### DETAILED DESCRIPTION OF THE PREFERRED EMBODIMENT

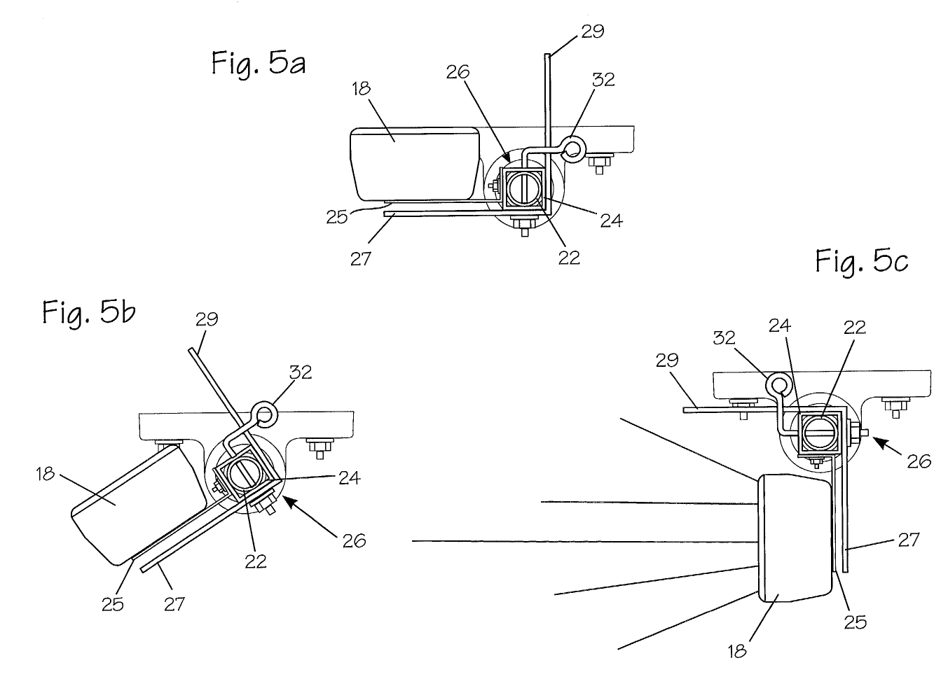

With reference to the drawings, in particular to FIGS. 1-7 thereof, the present invention, a retractable and concealable rearward light system denoted by reference numeral 10, will be described. A retractable rearward light system 10 is shown comprising an illumination system 12 and a rotational mechanism 14 controlled via a control device such as control box 16. In use, the illumination system 12 will rotate downward for providing additional lighting, as seen in FIGS. 1, 2, 3, and 5c. Or, when not in use, the illumination system will rotate upward, lights deactivated, for providing the present invention to be stored in non-obtruding position, as illustrated in FIGS. 4, 5a, 6 and 7. The control box 16 receives an electrical response and triggers the rotatable mechanism 14 to activate the illumination system 12 by moving lights 18 to an exposed downward (activation) position, or deactivate the system by moving the lights 18 to a concealed upward (deactivate) position.

To provide additional lighting, the illumination system 12, as seen in FIGS. 1-7, may include a plurality of conventional lights 18. The lights 18 are secured to a holding frame 20. This holding frame 20 will be mounted to the undersurface of a conventional vehicle A. The holding frame 20 may consist of an elongate unit, or the holding frame could comprise a combination of suitable brackets and mounting surfaces.

The holding frame 20 as shown in the figures comprises an elongate central shaft or axle 22. Surrounding the central shaft 22 is box sleeve 24. While the sleeve shown consists of square iron, a cylindrical tube or other type sleeve could be arranged to provide the needed mounting surfaces and support for the holding frame 20.The sleeve 24 partially surrounds the shaft 22, leaving the shaft's outer ends exposed to enable each end to be secured to a bearing 26. The bearing 26 allows the shaft 22 to rotate easily to move the illumination system 12 between the activated and deactivated positions. While the use of bearings 26 may be preferred in most applications of the invention, alternatives such as supporting the shaft 22 within a simple retainer allowing for rotation could be substituted at less expense.

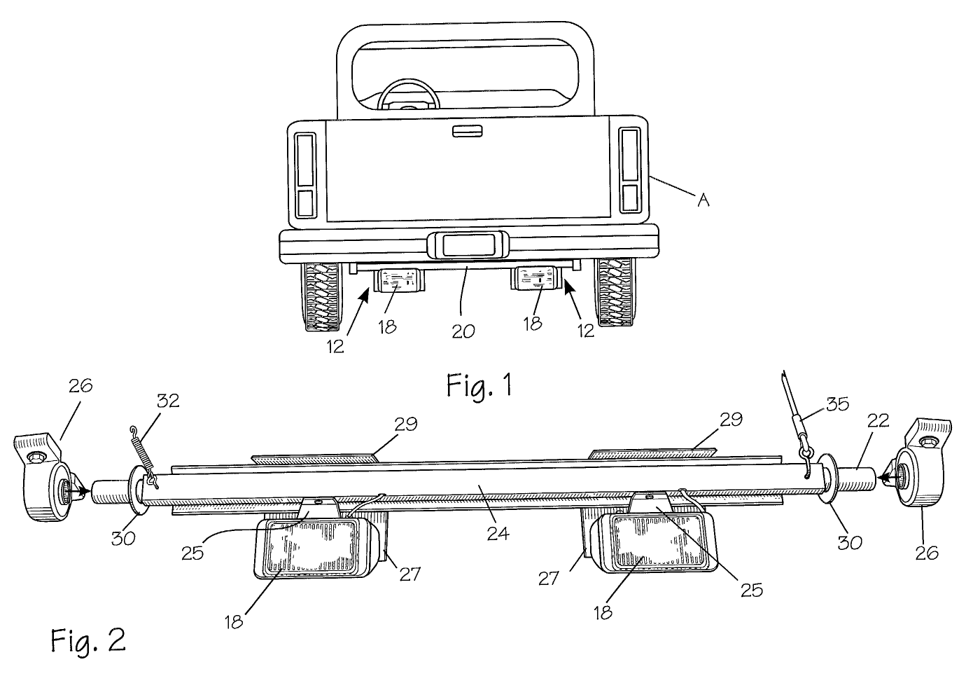

Apertures, illustrated in FIG. 2, but not labeled, extend through the box sleeve 24 and enable wiring from the lights 18 to extend therethrough. Having a box sleeve 24 around the shaft 22 provides an inherent flat surface for facilitating the attachment of elements thereto, and provides a convenient tube for hiding and protecting some of the required electrical wiring used in the invention. As seen in FIG. 2, a brace 25 secures the upper end of the lights 18 to this box sleeve 24. Thus, when the axle 22 rotates, the lights 18 will be raised or lowered, dependent upon the signal receive from the control box 16.

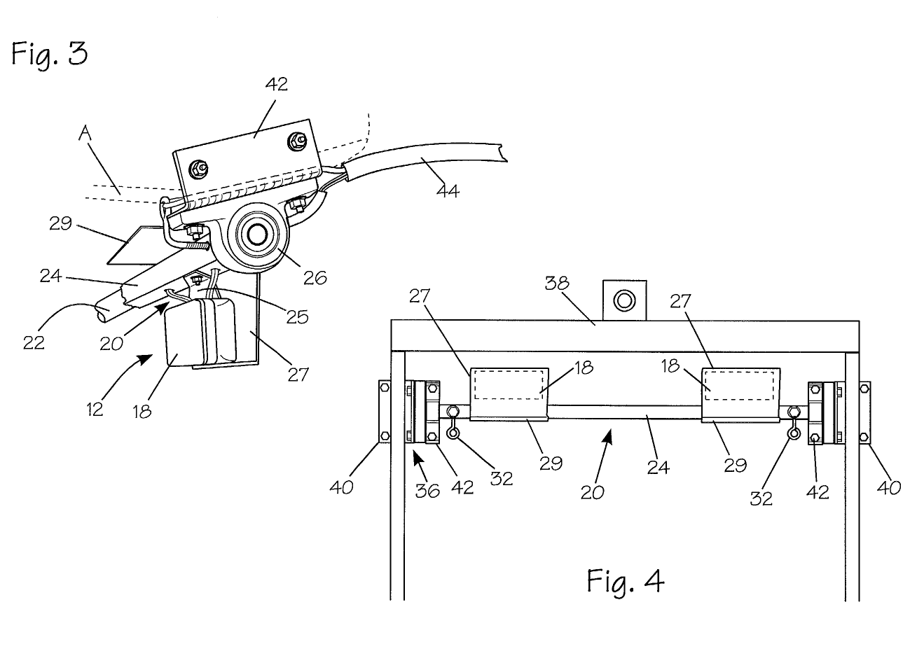

For more security and stability, the lights 18 can be rearwardly attached to the box sleeve 24 via rear support 27. As seen in FIG. 3, the light 18 is rearwardly attached to this rear support 27, which is attached to the box sleeve 24 portion of the holding frame 20. The rear support 27 may further function as a rock guard to prevent damage to the lights 18, wherein the rock guard 2 could remain detached and separate from the lights 18. Alternatively and for added protection, a second support 29 can be perpendicularly attached to the rear support 27 to provide a shield or rock guard above the lights 18. This will consequently provide for the rear support and second support to act as shields and prevent debris from marring and destroying the lights 18 and its wiring of the illumination system 12.

More structural stability can still be obtained by providing an angle iron 28 to be located between the box sleeve 24, rear support 27 and if used, second support 29. The angle iron will aid in the securement of the supports 27 and 29 to the box sleeve. Smooth rotational movement is achieved by the utilization of a washer 30, located on the axle 22, at each end of the box sleeve 24. This washer 30 will prevent the box sleeve 24 from contacting the bearing 26.

Extending through the box sleeve 24 and axle 22, and located in proximity to the outer ends of the box sleeve 24, are eyelet brackets 32 comprising a portion of the holding frame 20. An eyelet of a first of the eyelet brackets 32 will be coupled to the rotational mechanism 14 for allowing the shaft 22 to rotate in the desired direction to deploy and activate the illumination system 12. An eyelet of a second of the eyelet brackets may receive a spring 34; this spring is extended when the illumination assembly 12 is rotated into the downward position by the rotational mechanism 14. When it is desired to retract the assembly, the rotating mechanism 14 will cause the spring 34 to retract to it normal position, aiding in the upward transition. The spring 34 provides a biasing mechanism for retaining and orienting the illumination system 12 in the concealed position. However, it is contemplated that the system could be maintained in the deactivated position using other mechanical devices, electrical actuators, or even pneumatic devices. Similarly, mechanical, electrical, or pneumatic devices could be employed in providing both the rotational mechanism 14 and the connection to the shaft 22 needed to activate and deploy the illumination assembly 12 into the downward position for exposing the rearward lighting of the system. As shown the rotation mechanism 14 includes a cable 35 that is attached to the eyelet of the eyelet bracket 32 and is operated by a motor to push the cable 35 when rotation of the shaft 22 is desired.

As one manner of attaching the holding frame 20 to the undersurface of a vehicle A, the bearing 26 may include an attaching element 36 that enables the bearing to be attached. The attaching element 36 can be any conventional attaching device, such as brackets, as illustrated in FIG. 3 so as to enable the bearing 26 to be directly attached to the vehicle frame. Optionally, in another manner of attaching the holding frame 20 as seen in FIG. 4, the brackets can be designed and structured so that no marring or drilling is done to the vehicle or its components. As shown, this attaching method is ideally suited on vehicles with hidden trailer hitches, such as the trailer hitch 38 shown in FIG. 4. The attaching element, in this embodiment comprises an inner bracket 40 and an outer bracket 42 that are attached by bolts to clamp onto the frame of the trailer hitch 38.

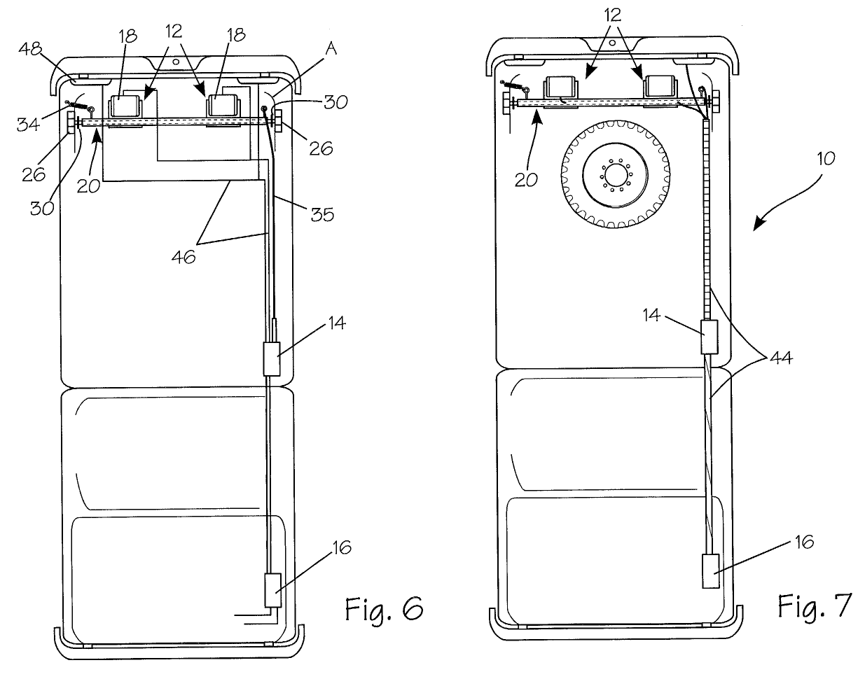

Rotation of the shaft 22 is initiated via the use of the control box 16 that is located on the vehicle A. Preferable, the control box 16, illustrated in FIGS. 6 and 7, is located in proximity to the motor of the conventional motor vehicle A. This will simplify the process of installing the box to the vehicle. The control box 16 is coupled electrically to the rotation mechanism 14 as well as to the battery of the conventional motor vehicle A. The rotation mechanism 14 is a motor or actuator controlled by the programming and input provided to the control box 16. Also coupled to the control box 16 may be the wiring to the vehicles' reverse lights 48 and to the plurality of lights 18 located on the illumination assembly 12. A conventional receiver may also be located in the control box 16. Via the control box 16, this receiver is connected to the wiring for the lights 18 located on the illumination system assembly and to the rotation mechanism to provide for remote control of the rearward light system 10. A wire loom, polymeric piping 44 or the like surrounds the wiring 46 for protection purposes.

In use, when the control box 16 receives a signal, such that the reverse lights are activated, reverse lights are deactivated, remote control unit activated, or the like, the signal is sent to the rotation mechanism 14. The rotation mechanism will cause the shaft 22 to rotate in the desired direction, causing the cable to be pulled or released. This movement will provide for the axle or shaft 22 to rotate freely about the bearing 26. Consequently causing the lights 18 to be raised or lowered. If the signal received is for activation, power is simultaneously sent to the lights 18 on the illumination assembly for providing the illumination of the plurality of lights.

While the present invention has been particularly shown and described with reference to an embodiment thereof, it will be understood by those skilled in the art that various changes in form and detail may be made without departing from the spirit and scope of the present invention.

I claim:

1. A vehicle light system, which comprises;
a holding frame;
an attachment device secured on an undersurface of a vehicle and supporting the holding frame beneath the vehicle;
an illumination assembly supported for rotational movement by the holding frame between a first position where the illumination assembly is retracted beneath the undersurface of the vehicle and a second position where the illumination assembly is extended below the undersurface of the vehicle and provides lighting directed rearward from the vehicle; and
a rotational mechanism for moving the illumination assembly between the first and second positions, the rotational mechanism comprising an actuating device and a control device connected to the holding frame.

2. A vehicle light system as in claim 1 in which the holding frame includes a shaft member, a guard member, and a brace for attaching a light.

3. A vehicle light system as in claim 2 in which the holding frame includes a box sleeve about a portion of the shaft member, and the guard member and the brace are attached to the box sleeve.

4. A vehicle light system as in claim 1 in which the attachment device includes bearings affixed to the undersurface of the vehicle and rotationally supporting a shaft member of the holding frame.

5. A vehicle light system as in claim 1 in which the attachment device includes a bracket attached to a hitch, which is attached to the undersurface of the vehicle.

6. A vehicle light system as in claim 1 in which the control device is remotely actuated by a remote control device situated on a key chain.

7. A vehicle light system as in claim 1 in which the control device is actuated by operating the vehicle in a reverse gear.

8. A vehicle light system as in claim 1 in which the actuating device is a motor connected to the holding frame by a cable.

9. A vehicle light system as in claim 1 in which the illumination assembly includes a pair of lights attached to the holding frame.

10. A vehicle light system comprising:
a holding frame having a shaft;
a means for securing the holding frame to an undersurface of a vehicle and supporting the holding frame beneath the vehicle;
a light supported for rotational movement by the holding frame between a first position where the light is retracted beneath the undersurface of the vehicle and a second position where the light is extended below the undersurface of the vehicle and provides lighting directed rearward from the vehicle; and
a rotational mechanism for rotating the shaft and moving the light between the first and second positions, the rotational mechanism comprising a motor, and a control device.

11. A light system device for attachment beneath an undersurface of a vehicle comprising:
a holding frame having a shaft;
an attachment device affixed to the holding frame for supporting the holding frame on the undersurface of a vehicle;
a light affixed to holding frame by a brace;
a motor connected by a cable to the holding frame;
a spring biasing member connected to the holding frame; and
a control device for actuating the motor to rotate the holding frame and expose the light for rearward illumination.

12. A light system as in claim 11 in which the attachment device includes a bracket affixed to the holding frame.

13. A light system as in claim 11 in which the attachment device includes a bearing attached to the shaft.

14. A light system as in claim 11 in which the holding frame includes a sleeve and the light are attached to the sleeve by the brace.

15. A light system as in claim 14 in which a first guard is attached to the sleeve behind the light and a second guard is attached to the sleeve above the light.

16. A light system as in claim 11 in which the attachment device include an inner bracket and an outer bracket for attaching the holding frame to a hitch.
